(19) United States
(12) Patent Application Publication
(10) Pub. No.: US 2015/0364143 A1
(43) Pub. Date: Dec. 17, 2015

(54) METHOD AND APPARATUS FOR TRANSMITTING AUDIO DATA

(71) Applicant: Samsung Electronics Co., Ltd., Gyeonggi-do (KR)

(72) Inventors: Rasmus ABILDGREN, Gyeonggi-do (KR); Sung-Hwan HYUN, Gyeonggi-do (KR); Kook-Hyung LEE, Seoul (KR); Hyung-Seoung YOO, Gyeonggi-do (KR); Chae-Hag YI, Gyeonggi-do (KR); Su-Hwan KIM, Gyeonggi-do (KR); Tae-Sung KIM, Gyeonggi-do (KR)

(73) Assignee: Samsung Electronics Co., Ltd.

(21) Appl. No.: 14/738,154

(22) Filed: Jun. 12, 2015

Related U.S. Application Data
(60) Provisional application No. 62/011,319, filed on Jun. 12, 2014.

(30) Foreign Application Priority Data
Sep. 5, 2014 (KR) 10-2014-0118906

(51) Int. Cl. G10L 19/008; H04R 5/04

(52) U.S. Cl. CPC G10L 19/008; H04R 5/04; H04R 2420/07

(57) ABSTRACT

An electronic device that uses a method of transmitting audio data is provided. The method includes encoding first audio data of a first audio stream section included in an audio stream, encoding second audio data of a second audio stream section included in the audio stream, transmitting the encoded first audio data to a first auxiliary device, and transmitting the encoded second audio data to a second auxiliary device after a time corresponding to a predetermined interval.

### PRIORITY

This application claims priority under 35 U.S.C. §119(e) to U.S. Provisional Patent Application Ser. No. 62/011,319, which was filed in the U.S. Patent and Trademark Office on Jun. 12, 2014, and under 35 U.S.C. §19(a) to Korean Patent Application Serial No. 10-2014-0118906, which was filed in the Korean Intellectual Property Office on Sep. 5, 2014, the entire disclosures of which are incorporated herein by reference.

### BACKGROUND

1. Field of the Disclosure

The present disclosure relates generally to a method and an apparatus for transmitting audio data by an electronic device, and more particularly, to an electronic device that outputs stereo sounds through auxiliary devices.

2. Description of the Related Art

According to the development of information communication technologies and semiconductor technologies, electronic devices have been developed as various multimedia devices that provide various multimedia services. For example, an electronic device may provide multimedia services, such as a voice call service, a video call service, a messenger service, a broadcast service, a wireless Internet service, a camera service, and a music reproduction service.

More particularly, recently developed electronic devices can provide multimedia services, and methods of providing various sounds of the multimedia services have been recently studied. For example, a method of providing sound of a multimedia service such as a mono sound or a stereo sound by the electronic device is currently being developed.

### SUMMARY

The present disclosure has been made to address at least the above mentioned problems and/or disadvantages and to provide at least the advantages described below

Accordingly, an embodiment of the present disclosure provides a method and an apparatus for outputting stereo sounds through auxiliary devices.

Another embodiment of the present disclosure provides a method and an apparatus for encoding audio data to be transmitted to a first auxiliary device and audio data to be transmitted to a second auxiliary device to have a time gap within the same audio stream.

Still another embodiment of the present disclosure provides a method and an apparatus for transmitting different pieces of audio data encoded to have a time gap within an audio stream to different wireless devices at different times.

Yet another embodiment of the present disclosure provides a method and an apparatus for supporting two different communication schemes during transmission of audio data.

Still another embodiment of the present disclosure provides a method and an apparatus for activating a second communication scheme after successfully transmitting audio data to another electronic device through a first communication scheme.

### BRIEF DESCRIPTION OF THE DRAWINGS

The above and other objects, features and advantages of the present disclosure will be more apparent from the following detailed description in conjunction with the accompanying drawings, in which:

FIG. 1 is a diagram illustrating a network environment including an electronic device, according to an embodiment of the present disclosure;

FIG. 2 is a block diagram illustrating a stereo sound control module, according to an embodiment of the present disclosure;

FIG. 3 is a diagram illustrating an example of encoding an audio stream by an electronic device, according to an embodiment of the present disclosure;

FIG. 4 is a diagram illustrating examples of times when stereo sounds are processed by an electronic device and wireless auxiliary devices, according to an embodiment of the present disclosure;

FIG. 5 is a flowchart illustrating a method in which an electronic device outputs a stereo sound, according to an embodiment of the present disclosure;

FIG. 6 is a diagram illustrating an example of providing stereo sounds through two different wireless devices by an electronic device, according to an embodiment of the present disclosure;

FIG. 7 is a block diagram of a communication scheme control module, according to an embodiment of the present disclosure;

FIG. 8 is a diagram illustrating an example for supporting two different communication schemes when an electronic device transmits audio data, according to an embodiment of the present disclosure;

FIG. 9 is a flowchart illustrating a method for supporting two different communication schemes when an electronic device transmits audio data, according to an embodiment of the present disclosure;

FIG. 10 is a flowchart illustrating a method in which an electronic device supports two different communication schemes, according to an embodiment of the present disclosure;

FIG. 11 is a diagram illustrating an example for supporting two different communication schemes when an electronic device transmits audio data to two different wireless devices, according to an embodiment of the present disclosure.

### DETAILED DESCRIPTION

Hereinafter, various embodiments of the present disclosure will be described with reference to the accompanying drawings. However, it should be understood that there is no intent to limit the present disclosure to the particular forms disclosed herein; rather, the present disclosure should be construed to cover various modifications, equivalents, and/or alternatives of embodiments of the present disclosure. In describing the drawings, similar reference numerals may be used to designate similar constituent elements.

As used herein, the expression “have”, “may have”, “include”, or “may include” refers to the existence of a corresponding feature (e.g., numeral, function, operation, or constituent element such as component), and does not exclude one or more additional features.

As used herein, the expression “A or B”, “at least one of A and/or B”, or “one or more of A and/or B” may include any or all possible combinations of items enumerated together. For example, the expression “A or B”, “at least one of A and B”, or “at least one of A or B” may include (1) at least one A, (2) at least one B, or (3) both at least one A and at least one B.

The expression “a first”, “a second”, “the first”, or “the second” used in various embodiments of the present disclosure may modify various components regardless of the order and/or the importance but does not limit the corresponding components. The expressions may be used to distinguish a component element from another component element. For example, a first user device and a second user device may indicate different user devices regardless of the sequence or importance thereof. For example, a first element may be termed a second element, and similarly, a second element may be termed a first element without departing from the scope of the present disclosure.

An element (e.g., a first element) described as being “(operatively or communicatively) coupled with/to or connected to” another element (e.g., a second element) should be construed as being directly connected to the another element or being indirectly connected to the another element via yet another element (e.g., a third element). Conversely, when an element is “directly coupled” or “directly connected” to another element, a third element does not exist between the first component element and the second element.

The expression “configured to” used in the present disclosure may be exchanged with, for example, “suitable for”, “having the capacity to”, “designed to”, “adapted to”, “made to”, or “capable of” according to the situation. The term “configured to” may not necessarily imply “specifically designed to” in hardware. Alternatively, in some situations, the expression “device configured to” may mean that the device, together with other devices or components, “is able to”. For example, the phrase “processor adapted (or configured) to perform A, B, and C” may mean a dedicated processor (e.g. embedded processor) only for performing the corresponding operations or a generic-purpose processor (e.g., central processing unit (CPU) or application processor (AP)) that can perform the corresponding operations by executing one or more software programs stored in a memory device.

The terms used in the present disclosure are only used to describe specific embodiments, and are not intended to limit the present disclosure. As used herein, singular forms may include plural forms as well unless the context clearly indicates otherwise. Unless defined otherwise, all terms used herein, including technical and scientific terms, have the same meanings as those commonly understood by a person skilled in the art to which the present disclosure pertains. Such terms as those defined in a generally used dictionary are to be interpreted to have meanings consistent with the contextual meanings in the relevant field of the art, and are not to be interpreted to have ideal or excessively formal meanings unless clearly defined in the present disclosure. In some cases, even the term defined in the present disclosure should not be interpreted to exclude embodiments of the present disclosure.

The “module” used in various embodiments of the present disclosure may refer to, for example, a “unit” including one of hardware, software, and firmware, or a combination of two or more of the hardware, software, and firmware. The “module” may be interchangeably used with, for example, the term “unit”, “logic”, “logical block”, “component”, or “circuit”. The “module” may be the smallest unit of an integrated component or a part thereof. The “module” may be the smallest unit that performs one or more functions or a part thereof. The “module” may be mechanically or electronically implemented. For example, the “module” according to various embodiments of the present disclosure may include at least one of an Application-Specific Integrated Circuit (ASIC) chip, a Field-Programmable Gate Arrays (FPGAs), and a programmable-logic device for performing operations which have been known or are to be developed hereafter.

For example, an electronic device described herein may include at least one of a smartphone, a tablet personal computer (PC), a mobile phone, a video phone, an electronic book (e-book) reader, a desktop PC, a laptop PC, a netbook computer, a personal digital assistant (PDA), a portable multimedia player (PMP), an MP3 player, a mobile medical appliance, a camera, and a wearable device (e.g., a head-mounted-device (HMD) such as electronic glasses, electronic clothes, an electronic bracelet, an electronic necklace, an electronic appcessory, electronic tattoos, or a smart watch).

The components of the electronic devices can be implemented in a base station or access point.

The electronic device may be a smart home appliance. The home appliance may include at least one of, for example, a television, a digital video disk (DVD) player, an audio, a refrigerator, an air conditioner, a vacuum cleaner, an oven, a microwave oven, a washing machine, an air cleaner, a set-top box, a home automation control panel, a security control panel, a TV box (e.g., Samsung HomeSync®, Apple TV®, or Google TV®, a game console (e.g., Xbox® and PlayStation®), an electronic dictionary, an electronic key, a camcorder, and an electronic photo frame.

The electronic device may include at least one of various medical devices (e.g., various portable medical measuring devices (a blood glucose monitoring device, a heart rate monitoring device, a blood pressure measuring device, a body temperature measuring device, etc.), a magnetic resonance angiography (MRA) device, a magnetic resonance imaging (MRI) device, a computed tomography (CT) machine, and an ultrasonic machine), a navigation device, a global positioning system (GPS) receiver, an event data recorder (EDR), a flight data recorder (FDR), a vehicle infotainment device, an electronic device for a ship (e.g., a navigation device for a ship, and a gyro-compass), avionics devices, security devices, an automotive head unit, a robot for home or industry, an automatic teller's machine (ATM) in banks, point of sales (POS) in a shop, or internet device of things (e.g., a light bulb, various sensors, electric or gas meter, a sprinkler device, a fire alarm, a thermostat, a streetlamp, a toaster, a sporting goods, a hot water tank, a heater, a boiler, etc.).

The electronic device may include at least one of a part of furniture or a building/structure, an electronic board, an electronic signature receiving device, a projector, and various kinds of measuring instruments (e.g., a water meter, an electric meter, a gas meter, and a radio wave meter). The electronic device may be a combination of one or more of the aforementioned various devices. The electronic device may be a flexible device. Further, the electronic device is not limited to the aforementioned devices, and may include an electronic device according to the development of technology.

Hereinafter, an electronic device will be described with reference to the accompanying drawings. The term “user” used in the present specification may refer to a person or a device (for example, an artificial intelligence electronic device) using an electronic device.

The electronic device described herein may divide an audio stream into a first audio stream section and a second audio stream section, which have a time gap therebetween, encode the divided stream sections, and transmit encoded first audio data and second audio data to two different wireless auxiliary devices with a predetermined time gap.

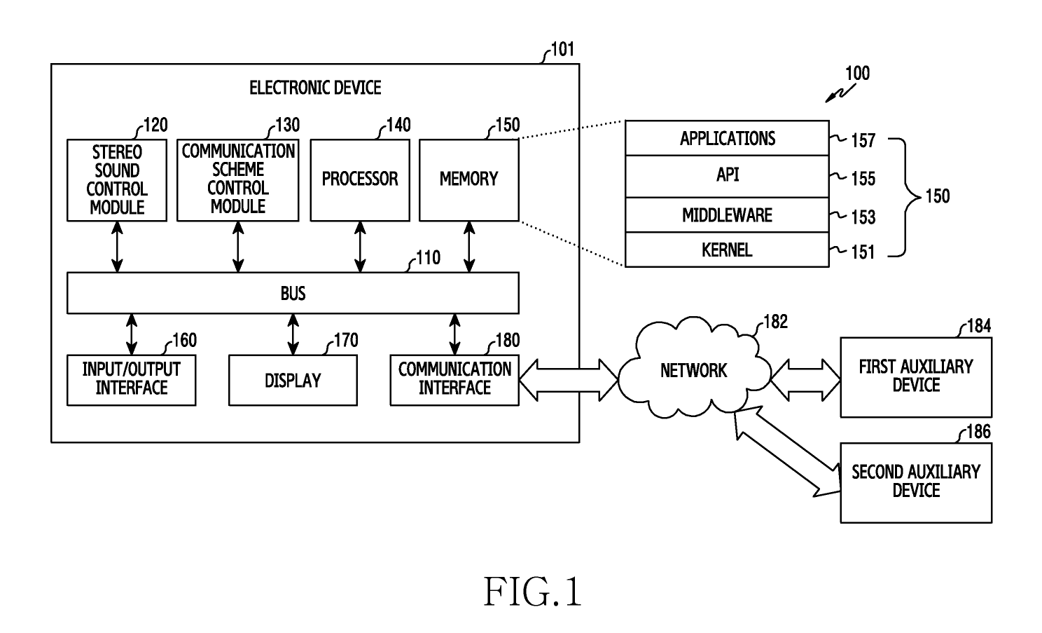

FIG. 1 is a diagram illustrating a network environment including an electronic device 101, according to an embodiment of the present disclosure.

Referring to FIG. 1, the electronic device 101 includes a bus 110, a stereo sound control module 120, a communication scheme control module 130, a processor 140, a memory 150, an input/output interface 160, a display 170, and a communication interface 180.

The bus 110 may be a circuit that is used to connect the above described components to one another and so that communication (for example, a control message) between the above described components may be obtained.

The stereo sound control module 120 divides an audio stream into different audio stream sections, such as a first audio stream section and a second audio stream section, which have a time gap therebetween, encode the divided audio stream sections, and transmit encoded first audio data and second audio data to two different auxiliary device (e.g., a first auxiliary device 184 and a second auxiliary device 186) with a time gap.

The stereo sound control module 120 determines a first audio stream section and a second audio stream section to be encoded, in the same audio stream, and then encodes audio data corresponding to each of the audio stream sections. A starting point of the second audio stream section may be located after a predetermined interval from a starting point of the first audio stream section, and lengths of the first audio stream section and the second audio stream section may be the same as each other. Further, the stereo sound control module 120 transmits the audio data of the first audio stream section to the first auxiliary device 184 and transmits the encoded audio data of the second audio stream section to the second auxiliary device 186, after a time corresponding to the predetermined interval. The size of the predetermined interval indicating a time gap between the first audio stream section and the second audio stream section may be predetermined by experimentation or determined based on time synchronization of two wireless auxiliary devices that are connected to the electronic device 101. The wireless auxiliary devices can be electronic devices that have an audio data output function, for example, wireless headsets, wireless earphones, wireless hearing aids, and wireless speakers. Further, the first auxiliary device 184 may be an electronic device for outputting right audio data and the second auxiliary device 186 may be an electronic device for outputting left audio data.

The communication scheme control module 130 controls the activation and deactivation of a second wireless communication scheme in an audio data transmission section based on a first wireless communication scheme. For example, the audio data transmission section, which is based on the first wireless communication scheme, may be classified into an initial transmission section in which audio data is initially transmitted and a retransmission section in which audio data is retransmitted when transmission of the audio data fails in the initial transmission section. When the audio data is successfully transmitted to the wireless auxiliary device, in the initial transmission section of the audio data based on the first wireless communication scheme, the communication scheme control module 130 activates the second wireless communication scheme and transmits/receives data through the second wireless communication scheme without retransmitting the corresponding audio data in the retransmission section of the audio data. The communication scheme control module 130 also activates the second wireless communication scheme in some of the initial transmission section of the audio data and transmits/receives data through the second wireless communication scheme until the retransmission section of the audio data ends. For example, the communication scheme control module 130 activates the second wireless communication scheme at a time the successful transmission of the audio data in the initial transmission section is detected, and transmits/receives data through the second wireless communication scheme until the retransmission section of the audio data ends. The data transmitted/received through the activated second wireless communication scheme may be data related to audio data or another piece of data irrelevant to audio data.

The processor 140 receives commands from other components of the electronic device 101 (for example, the stereo sound control module 120, the communication scheme control module 130, the memory 150, the input/output interface 160, the display 170, and the communication interface 180) through the bus 110, analyzes the received commands, and performs calculations or data processing according to the analyzed commands.

The memory 150 stores commands or data received from or generated by the processor 140 or other components (for example, the stereo sound control module 120, the communication scheme control module 130, the memory 150, the input/output interface 160, the display 170, and the communication interface 180). The memory 150 includes programming modules such as, for example, a kernel 151, middleware 153, an application Programming Interface (API) 155, and/or applications 157. Each of the programming modules may be implemented by software, firmware, hardware, or a combination of two or more thereof.

The input/output interface 160 transfers commands or data input by a user through an input device (for example, a sensor, a keyboard, or a touch screen) to the stereo sound control module 120, the communication scheme control module 130, the processor 140, the memory 150, or the communication interface 180 by using, for example, the bus 110. For example, the input/output interface 140 provides the processor 140 with data on a user's touch input through a touch screen.

The display 170 displays various pieces of information (for example, multimedia data or text data) to a user. For example, the display 170 displays commands or data received from the stereo sound control module 120, the communication scheme control module 130, the processor 140, the memory 150, and the communication interface 180 through the bus 110.

The communication interface 180 provides a communication interface between the electronic device 101 and an external device (for example, the first auxiliary device 184 or the second auxiliary device 186). For example, the communication interface 180 may be connected to a network 182 through wireless communication and communicate with the first auxiliary device 184 or the second auxiliary device 186. The wireless communication may include at least one of, for example, wi-fi, bluetooth (BT), near field communication (NFC), GPS and cellular communication (for example, LTE, LTE-A, CDMA, WCDMA, UMTS, WiBro, or GSM).

A protocol (for example, a transport layer protocol, data link layer protocol, or physical layer protocol) for the communication between the electronic device 101 and the first and second auxiliary devices 184, 186 may be supported by at least one of the applications included in the memory 150, the API 155, the middle, the kernel 151, or the communication interface 180.

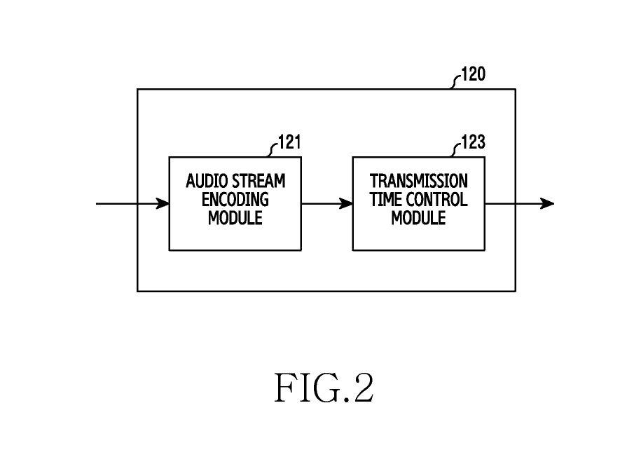

FIG. 2 is a block diagram of the stereo sound control module for outputting a stereo sound, according to an embodiment of the present disclosure.

Referring to FIG. 2, the stereo sound control module 120 includes an audio stream encoding module 121 and a transmission time control module 123.

The audio stream encoding module 121 encodes a first audio stream section and a second audio stream section which have a time gap in an audio stream section. Specifically, the stereo sound control module 121 determines a first audio stream section and a second audio stream section to be encoded in the same audio stream, and encodes audio data corresponding to each of the audio stream sections. It is also determined if a starting point of the first audio stream and a starting point of the second audio stream section have a gap corresponding to a predetermined interval. As noted above, a size of the predetermined interval indicating a time gap between the first audio stream section and the second audio stream section may be predetermined by experimentation or determined based on time synchronization of the two wireless auxiliary devices connected to the electronic device.

The audio stream encoding module 121 transmits first audio data generated by encoding the first audio stream section and second audio data generated by encoding the second audio stream section to the transmission time control module 123. The audio stream encoding module 121 transmits time information corresponding to the time gap between the starting point of the first audio stream section and the starting point of the second audio stream section to the transmission time control module 123.

The transmission time control module 123 transmits the first audio data received from the audio stream encoding module 121 to the first auxiliary device and transmits the second audio data to the second auxiliary device after a predetermined time. Specifically, the transmission time control module 123 transmits the first audio data to the first auxiliary device and transmits the second audio data to the second auxiliary device after a time corresponding to the time gap between the starting point of the first audio stream section and the starting point of the second audio stream section. When the time information is received from the audio stream encoding module 121, the transmission time control module 123 transmits the first audio data to the first auxiliary device and transmits the second audio data to the second auxiliary device after a time corresponding to the received time information. When the time information is not received from the audio stream encoding module 121, the transmission time control module 123 identifies the time gap between the starting point of the first audio stream section and the starting point of the second audio stream section based on the first audio data and the second audio data, transmits the first audio data to the first auxiliary device, and transmits the second audio data to the second auxiliary device after a time corresponding to the identified time gap.

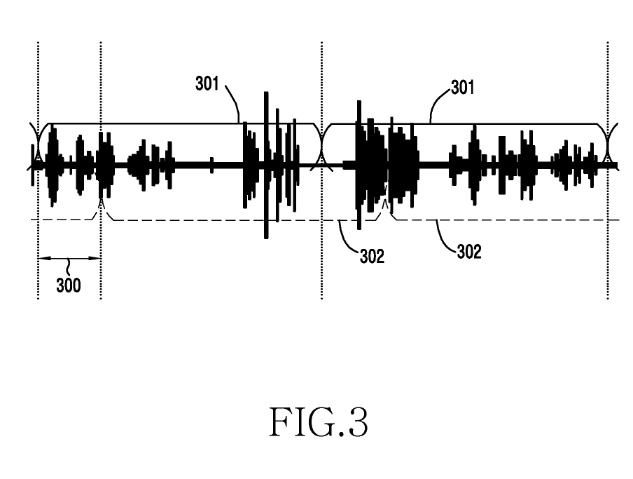

FIG. 3 is a diagram illustrating an example of encoding an audio stream by the electronic device 101, according to an embodiment of the present disclosure.

Referring to FIG. 3, the electronic device 101 encodes a first audio stream section 301 and a second audio stream section 302, which have a time gap 300 therebetween in an audio stream section. In other words, the electronic device 101 determines the first audio stream section 301 and the second audio stream section 302, which have the time gap 300 therebetween in the same audio stream, and encodes audio data corresponding to each of the audio stream sections 301 and 302. It may also be determined if a starting point of the first audio stream 301 and a starting point of the second audio stream section 302 have a time gap corresponding to a predetermined interval 300 therebetween. For example, it may be determined if the starting point of the second audio stream section is located after the predetermined interval from the starting point of the first audio stream section.

Further, lengths of the first audio stream section 301 and the second audio stream section 302 may be the same as each other. For example, it may be determined that the starting point of the second audio stream section 302 is located after a predetermined interval from the starting point of the first audio stream section 301 and a length of the second audio stream section 302 is the same as a length of the first audio stream section 301.

The electronic device 101 transmits first audio data acquired by encoding the first audio stream section 301 to the first auxiliary device 184 through wireless communication and transmits second audio data acquired by encoding the second audio stream section to the second auxiliary device 186 through wireless communication. The electronic device 101 transmits the first audio data and the second audio data based on the time gap corresponding to the interval between the starting point of the first audio stream section and the starting point of the second audio stream section. For example, the electronic device 101 transmits the first audio data to the first wireless auxiliary device 184 through wireless communication and transmits the second audio data to the second wireless auxiliary device 186 through wireless communication after a time corresponding to the interval between the starting point of the first audio stream section and the starting point of the second audio stream section. The electronic device transmits audio data to the first auxiliary device 184 and the second auxiliary device 186 through a bluetooth low energy (BLE) communication scheme. The first auxiliary device 184 and the second auxiliary device 186 may be devices that receive audio data from the electronic device 101 through wireless communication and outputs the received audio data, and the first and second auxiliary devices 184, 186 may be wireless devices. For example, the first auxiliary device 184 may be a left wireless hearing aid and the second auxiliary device 186 may be a right wireless hearing aid. In another example, the first auxiliary device 184 may be a right wireless hearing aid and the second auxiliary device 186 may be a left wireless hearing aid. In still another example, the first auxiliary device 184 may be a left wireless BT earphone and the second auxiliary device 186 may be a right wireless BT earphone. In yet another example, the first auxiliary device 184 may be a right wireless BT earphone and the second auxiliary device 186 may be a left wireless BT earphone.

The first and second auxiliary devices 184, 186, having received the encoded audio data, may decode the audio data without regard to time synchronization with the counterpart auxiliary device. The audio data received from each of the auxiliary devices is directly output, and thus power consumption and complexity of the auxiliary devices can be reduced.

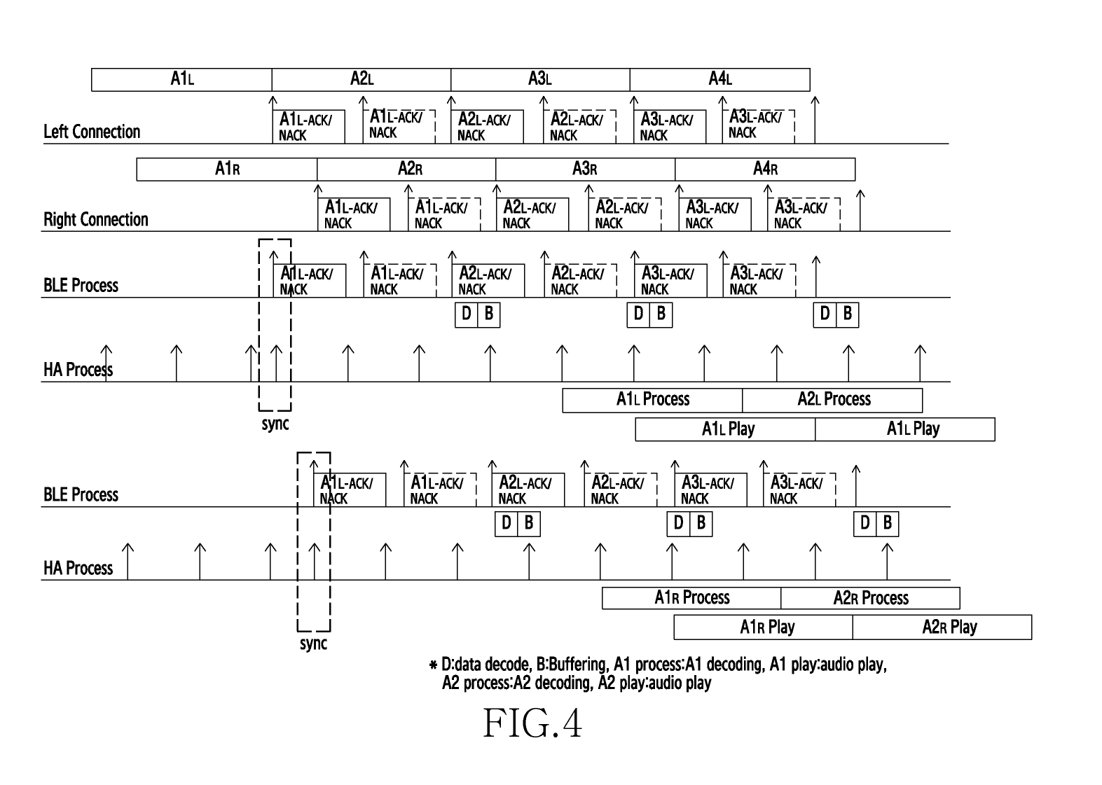

FIG. 4 is a diagram illustrating examples of times when stereo sounds are processed by the electronic device 101 and the first and second wireless auxiliary devices 184, 186, according to an embodiment of the present disclosure.

Referring to FIG. 4, the electronic device 101 encodes audio data to be transmitted to a left wireless auxiliary device, e.g., the first wireless auxiliary device 184, and audio data to be transmitted to a right wireless auxiliary device, e.g., the second wireless auxiliary device 186, in a state where the electronic device 101 is connected to the left wireless auxiliary device and the right wireless auxiliary device. The audio data to be transmitted to the left wireless auxiliary device and the audio data to be transmitted to the right wireless auxiliary device may have a preset time gap therebetween.

The electronic device 101 transmits encoded audio data A1L, A2L, A3L, and A4L to the left wireless auxiliary device, and transmits encoded audio data A1R, A2R, A3R, and A4R to the right wireless auxiliary device after a preset time elapses from an A1L transmission start point. The electronic device 101 receives response signals of the encoded data from the left wireless auxiliary device and the right wireless auxiliary device. For example, the electronic device 101 receives, from the left wireless auxiliary device, response data A1L_ACK/NACK indicating whether the encoded data A1L is successfully received, and receives, from the right wireless auxiliary device, response data A1R_ACK/NACK indicating the encoded audio data A1R is successfully received. When the electronic device 101 receives, from the left wireless auxiliary device, the response data A1L_ACK indicating that the encoded data A1L is successfully received, the electronic device 101 does not retransmit the encoded audio data A1L. When the electronic device 101 receives, from the left wireless auxiliary device, the response data A1L_NACK indicating that the encoded audio data A1L is not successfully received, the electronic device 101 retransmits the encoded audio data A1L and re-receives response data indicating whether the encoded audio data A1L is successfully received.

The left wireless auxiliary device receives the encoded audio data A1L, A2L, A3L, and A4L from the electronic device 101 and transmits the response data indicating whether each of the encoded audio data A1L, A2L, A3L, and A4L is successfully received to the electronic device 101. The left wireless auxiliary device performs synchronization of an audio data processing time by the electronic device 101 based on a time when the encoded audio data A1L is completely received from the electronic device 101, decodes and buffers the encoded audio data A1L, and processes and output the decoded audio data A1L according to the synchronized audio data processing time. The left wireless auxiliary device processes the encoded audio data A2L, A3L, and A4L in the same way as that of the encoded audio data A1L.

The right wireless auxiliary device receives the encoded audio data A1R, A2R, A3R, and A4R from the electronic device 101 and transmits the response data indicating whether each of the encoded audio data A1R, A2R, A3R, and A4R is successfully received to the electronic device 101. The right wireless auxiliary device performs synchronization of an audio data processing time by the electronic device 101 based on a time when the encoded audio data A1R is completely received from the electronic device 101, decodes and buffers the encoded audio data A1R, and processes and outputs the decoded data AIR according to the synchronized audio data processing time. The right wireless auxiliary device processes the encoded audio data A2R, A3R, and A4R in the same way as that of the encoded data A1R.

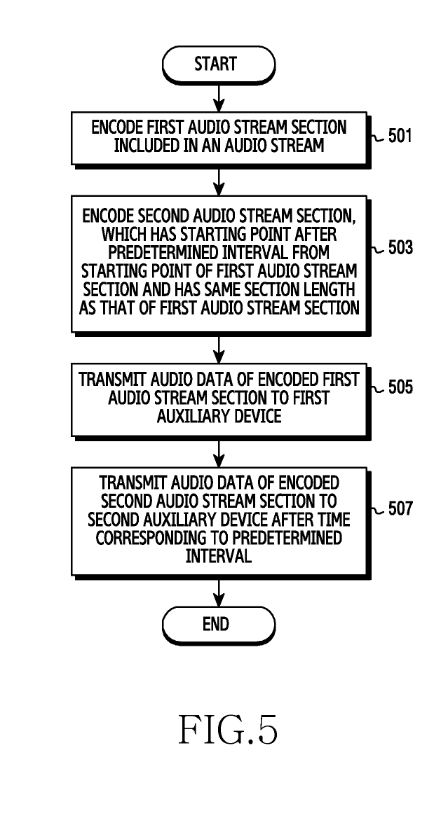

FIG. 5 is a flowchart illustrating a method in which the electronic device 101 outputs a stereo sound, according to an embodiment of the present disclosure.

Referring to FIG. 5, the electronic device 101 encodes a first audio stream section included in an audio stream at step 501. In other words, the electronic device 101 encodes audio data corresponding to the first audio stream section.

The electronic device 101 encodes a second audio stream section which has a starting point after a predetermined interval from a starting point of the first audio stream section and has the same section length as that of the first audio stream section at step 503. Specifically, the electronic device 101 encodes the first audio stream section and the second audio section included in the same audio stream. The starting point of the second audio stream section may be located after a predetermined interval from the starting point of the first audio stream section, and lengths of the first audio stream section and the second audio stream section may be the same as each other.

The electronic device 101 transmits audio data of the encoded first audio stream section to the first auxiliary device 184 at step 505. The electronic device 101 transmits the audio data to the first auxiliary device 184 through wireless communication. For example, the electronic device 101 transmits the audio data to the first auxiliary device 184 through a BLE communication scheme.

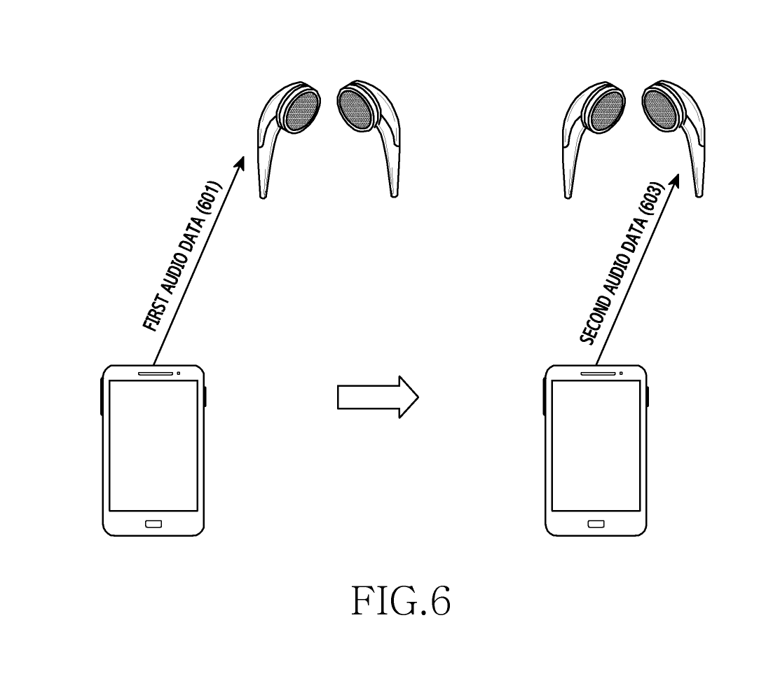

The electronic device 101 transmits audio data of the encoded second audio stream section to a second auxiliary device 186 after a time corresponding to a predetermined interval at step 507. The first auxiliary device 184 and the second auxiliary device 186 may be a pair of devices and may correspond to wireless devices which may output audio data received from the electronic device 101. For example, as illustrated in FIG. 6, the electronic device 101 may start transmission 601 of encoded first audio data to a left hearing aid corresponding to the first auxiliary device 184 and start transmission 603 of encoded second audio data to a right hearing aid corresponding to the second auxiliary device 186 after a predetermined time elapses after a transmission start time of the first audio data.

The electronic device 101 may then terminate the process.

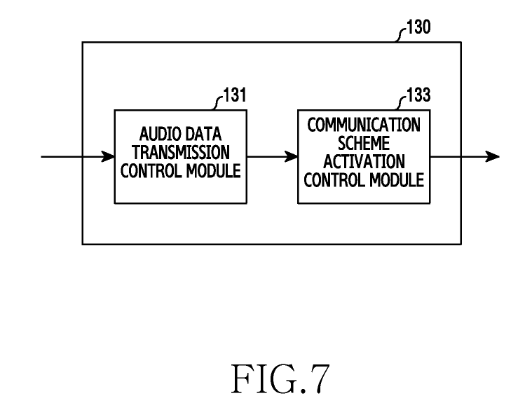

FIG. 7 is a block diagram of the communication scheme control module for supporting two different communication schemes when audio data is transmitted, according to an embodiment of the present disclosure.

Referring to FIG. 7, the communication scheme control module 130 includes an audio data transmission control module 131 and a communication scheme activation control module 133.

The audio data transmission control module 131 transmits audio data to an auxiliary device, e.g., a first auxiliary device 184, in a first transmission section for transmission of audio data based on a first wireless communication scheme. For example, the audio data transmission control module 131 transmits audio data to a hearing aid corresponding to the auxiliary device through a BLE communication scheme in the first transmission section for transmission of audio data. The transmission section includes a first transmission section (or an initial transmission section) for transmitting audio data and a second transmission section (or a retransmission section) for retransmitting the corresponding audio data when the transmission of the corresponding audio data fails.

The audio data transmission control module 131 identifies whether the audio data transmitted in the first transmission section is successfully received by the auxiliary device. In other words, the audio data transmission control module 131 transmits audio data to the auxiliary device in the first transmission section through the first wireless communication scheme and identifies whether a response signal of the audio data is received from the corresponding auxiliary device.

When the response signal of the audio data is received from the auxiliary device, the communication scheme activation control module 133 activates a second wireless communication scheme in some of the second transmission section for retransmitting audio data from the section after the time when the response signal is received.

The communication scheme activation control module 133 activates the second wireless communication scheme at the time when the successful transmission of the audio data in the first transmission section is detected, and transmits/receives data through the second wireless communication scheme until the retransmission section of the audio data ends. For example, when the audio data is successfully transmitted to the auxiliary device in the first transmission section through the BLE communication scheme, the communication scheme activation control module 133 activates a WiFi communication scheme at the time when the successful transmission of the audio data is detected.

Further, the communication scheme activation control module 133 activates the second wireless communication scheme in the section after the time when the successful transmission of the audio data is detected and some of the retransmission section of the audio data and transmits/receives data through the second wireless communication scheme. For example, when the audio data is successfully transmitted to the auxiliary device in the first transmission section through the BLE communication scheme, the communication scheme activation control module 133 activates a WiFi communication scheme in some sections from the time when the successful transmission of the audio data is detected to the time before the retransmission section ends.

Further, when the successful transmission of the audio data in the first transmission section is detected, the communication scheme activation control module 133 activates the second wireless communication scheme in all or some of the second transmission section for retransmitting the corresponding audio data. For example, when the audio data is successfully transmitted to the auxiliary device in the first transmission section through the BLE communication scheme, the communication scheme activation control module 133 activates the WiFi communication scheme in the second transmission section.

In a state where the electronic device 101 transmits audio data to two auxiliary devices (for example, a right auxiliary device and a left auxiliary device), when the communication scheme activation control module 133 receives a response signal indicating successful reception of the audio data in the first transmission section from at least one of the right auxiliary device and the left auxiliary device, the communication scheme activation control module 133 activates the second wireless communication scheme in the second transmission section.

In a state where the electronic device 101 transmits audio data to two auxiliary devices (for example, a right auxiliary device and a left auxiliary device), when the communication scheme activation control module 133 receives a response signal indicating successful reception of the audio data in the first transmission section from at least one of the right auxiliary device and the left auxiliary device, the communication scheme activation control module 133 activates the second wireless communication scheme at the corresponding time.

The communication scheme activation control module 133 transmits/receives data through the second wireless communication scheme. In the first transmission section for transmitting next audio data, the communication scheme activation control module 133 inactivates the activated second wireless communication scheme and transmits audio data based on the first wireless communication scheme.

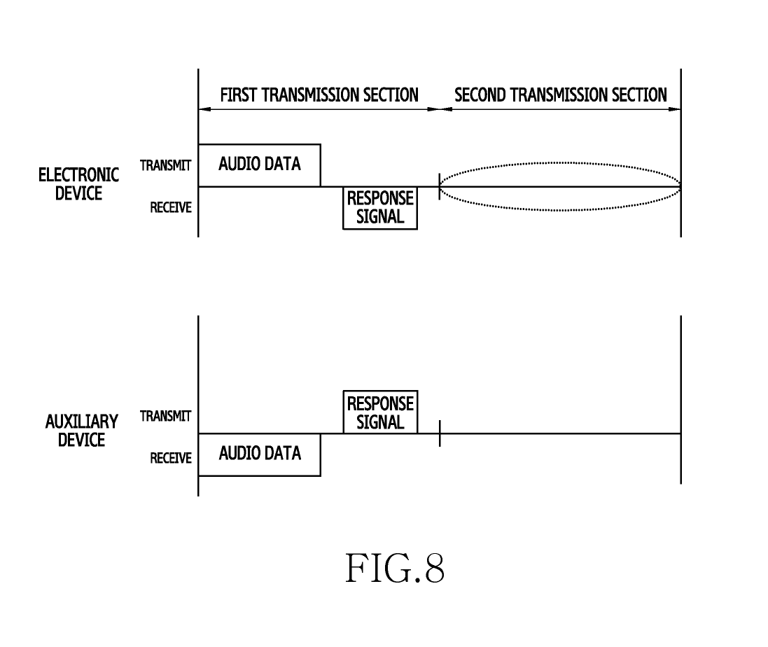

FIG. 8 is a diagram illustrating an example for supporting two different communication schemes when the electronic device 101 transmits audio data, according to an embodiment of the present disclosure.

Referring to FIG. 8, the electronic device 101 transmits audio data to an auxiliary device, e.g., the first auxiliary device 184, through a first communication scheme in a first transmission section for transmission of audio data. For example, the electronic device 101 transmits audio data to the auxiliary device through a BLE communication scheme in the first transmission section for transmission of audio data.

The auxiliary device receives the audio data transmitted from the electronic device 101 through the first wireless communication scheme and transmits a response signal indicating successful reception of the audio data to the electronic device 101 through the first wireless communication scheme. For example, the auxiliary device receives the audio data transmitted from the electronic device 101 through a BLE communication scheme and transmits a response signal (for example, an ACK signal) indicating successful reception of the audio data to the electronic device 101 through the BLE communication scheme.

When the electronic device 101 receives the response signal indicating the successful reception of the audio data from the auxiliary device through the first wireless communication scheme, the electronic device 101 determines that retransmission of the corresponding audio data is not required and activates the second wireless communication scheme in the second transmission section for retransmission of the audio data. For example, when the electronic device 101 receives the ACK signal indicating the successful reception of the audio data from the auxiliary device through the BLE communication scheme, the electronic device 101 activates a WiFi communication scheme in the second transmission section. Although not illustrated, when the electronic device 101 receives the response signal indicating the successful reception of the audio data from the auxiliary device through the first wireless communication scheme, the electronic device 101 determines that retransmission of the corresponding audio data is not required and activates the second wireless communication scheme at the time when the response signal is received. For example, when the electronic device 101 receives the ACK signal indicating the successful reception of the audio data from the auxiliary device through the BLE communication scheme, the electronic device 101 activates the WiFi communication scheme at the time when the ACK signal is received.

Thereafter, the electronic device 101 transmits/receives data through the second communication scheme.

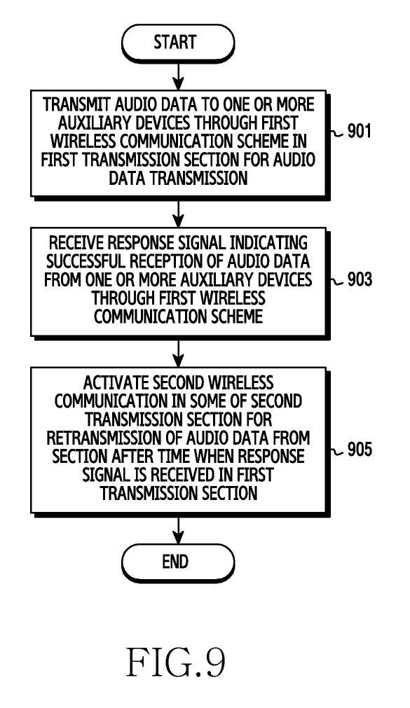

FIG. 9 is a flowchart illustrating a method for supporting two different communication schemes when the electronic device 101 transmits audio data, according to an embodiment of the present disclosure.

Referring to FIG. 9, the electronic device 101 transmits audio data to at least one auxiliary device, e.g., the first auxiliary device 184, through a first communication scheme in a first transmission section for transmission of audio data at step 901.

The electronic device 101 receives a response signal indicating successful reception of the audio data from at least one auxiliary device through the first wireless communication scheme at step 903.

The electronic device 101 activates a second wireless communication scheme in some of a second transmission interval for retransmission of the audio data from a section after the time when the response signal is received in the first transmission section at step 905. For example, the electronic device 101 activates the second wireless communication scheme at the time when the response signal is received from the auxiliary device. In another example, the electronic device 101 activates the second wireless communication scheme in the second transmission section for retransmission of the audio data.

Thereafter, the electronic device 101 may terminate the process.

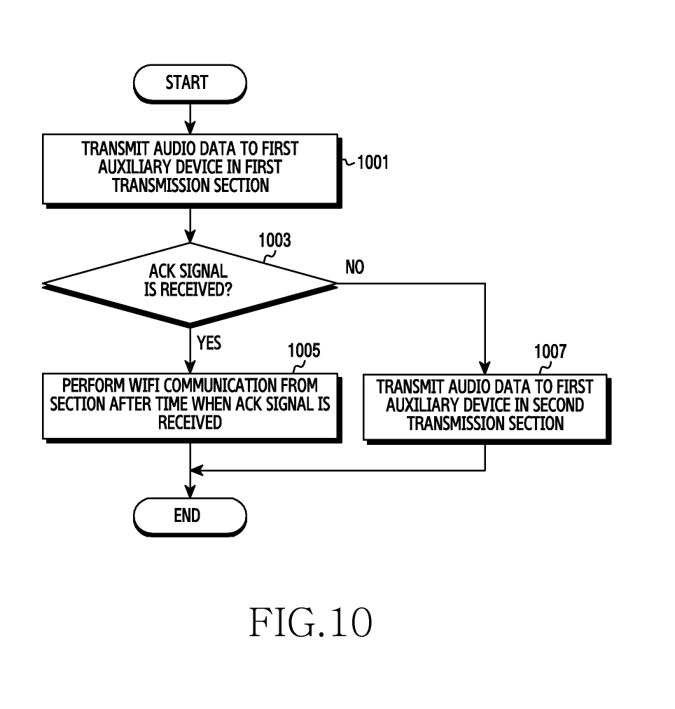

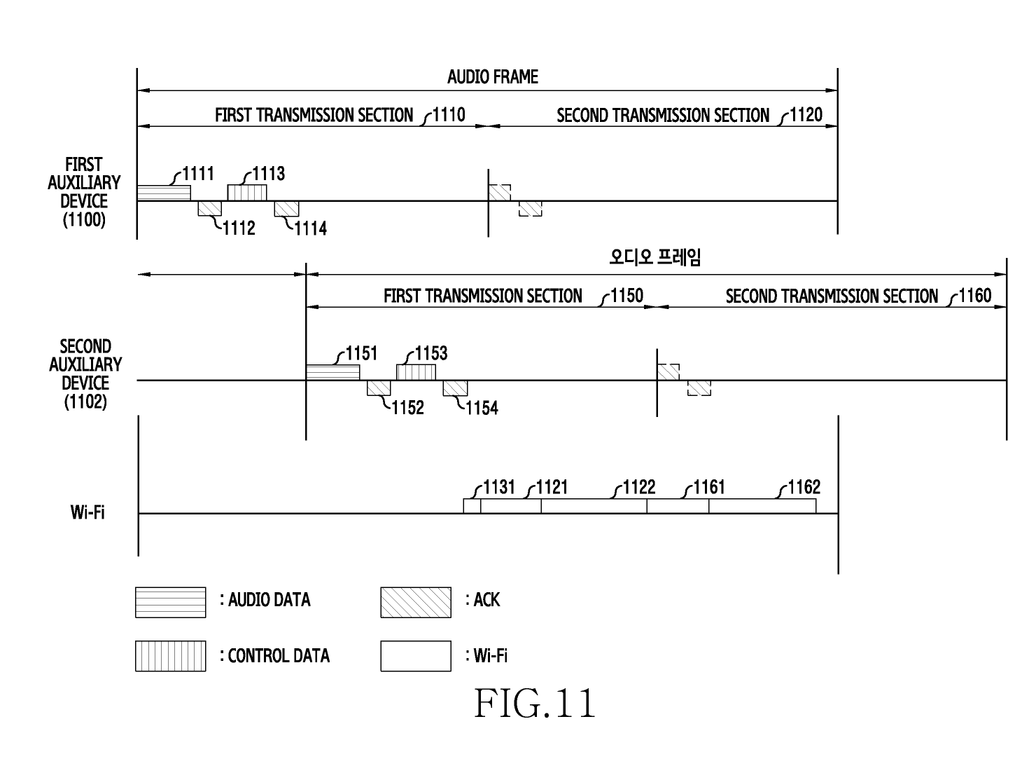

FIG. 10 is a flowchart illustrating a method in which the electronic device 101 supports two different communication schemes, and FIG. 11 is a diagram illustrating an example for supporting two different communication schemes when the electronic device 101 transmits audio data to two different wireless devices, according to an embodiment of the present disclosure.

Referring to FIG. 10, the electronic device 101 transmits audio data to a first auxiliary device through a first wireless communication scheme in a first transmission section for transmission of audio data. The electronic device may additionally transmit control data for controlling the first auxiliary device as well as the audio data in the first transmission section.

The electronic device 101 identifies whether an ACK signal indicating successful reception of the audio data is received from the first auxiliary device at step 1003. When the electronic device 101 does not receive an ACK signal indicating the successful reception of the audio data from the first auxiliary device, for example, when the electronic device 101 receives a NACK signal indicating failure of reception of the audio data from the first auxiliary device, the electronic device 101 transmits the audio data to the first auxiliary device in the second transmission section at step 1007.

When the electronic device 101 receives the ACK signal indicating the successful reception of the audio signal from the first auxiliary device, the electronic device 101 performs WiFi communication from the section after the time when the ACK signal is received at step 1005. For example, the electronic device 101 performs WiFi communication by activating a WiFi module at the time when the ACK signal is received. In another example, the electronic device 101 performs WiFi communication by activating a WiFi module in the second transmission section.

Although FIG. 10 describes that the electronic device 101 transmits audio data only to the first auxiliary device 184, the same operation as that of FIG. 10 may be performed for the second auxiliary device 186 when the electronic device 101 transmits the audio data to the first auxiliary device 184 and the second auxiliary device 186.

When the electronic device 101 transmits audio data to both the first auxiliary device 184 and the second auxiliary device 186, the electronic device 101 performs the transmission in a first transmission section 1110 of a first auxiliary device 1100 and a first transmission section 1150 of a second auxiliary device 1102, which have a time gap therebetween (see FIG. 11, for example). Accordingly, a second transmission section 1120 of the first auxiliary device 1100 and a second transmission section 1160 of the second auxiliary device 1102 may also have a time gap therebetween.

When the electronic device 101 successfully transmits audio data to the first auxiliary device 1100 in the first transmission section 1110 and successfully transmits audio data to the second auxiliary device 1102 in the first transmission section 1150, the electronic device 101 performs WiFi communication 1121, 1122, 1161, and 1162 in the second transmission section 1120 of the first auxiliary device 1100.

Further, when the electronic device 101 successfully transmits audio data to the first auxiliary device 1100 in the first transmission section 1110 and successfully transmit audio data to the second auxiliary device 1102 in the first transmission section 1150, the electronic device 101 performs WiFi communication 1131, 1121, 1122, 1161, and 1162 from the time when an ACK signal 1152 indicating successful reception of the audio data is received to the second transmission section 1120 of the first auxiliary device 1100 in the first transmission section 1150 of the second auxiliary device 1102, which is temporally later than the first transmission section 1110 of the first auxiliary device 1100.

When the first auxiliary device 1100 successfully receives the audio data but a situation corresponding to transmission/reception of a synchronization signal in the second transmission section 1120 occurs, the synchronization signal is transmitted/received through the first wireless communication in the section for transmission/reception of the synchronization signal. Accordingly, WiFi communication 1131, 1122, 1161, and 1162 corresponding to second wireless communication may be performed only in sections except for the corresponding section.

Further, when the second auxiliary device 1102 successfully receives the audio data but a situation corresponding to transmission/reception of a synchronization signal in the second transmission section 1160 occurs, the synchronization signal is transmitted/received through the first wireless communication in the corresponding section. Accordingly, WiFi communication 1131, 1121, 1122, and 1162 corresponding to second wireless communication may be performed only in sections except for the corresponding section.

In addition, when the electronic device 101 receives an NACK signal indicating failure of reception of the audio data from the first auxiliary device 1100, the electronic device 101 retransmits the audio data to the first auxiliary device 1100 in the second transmission section 1120. When the audio data is successfully transmitted to the second auxiliary device 1102 in the first transmission section 1150, the electronic device 101 performs WiFi communication only in sections except for the section in which the audio data is retransmitted to the first auxiliary device 1100 from the time when the ACK signal 1152 is received from the second auxiliary device 1102 to an end of the second transmission section 1120 of the second auxiliary device 1102. At this time, even when the electronic device 101 receives the NACK signal indicating the failure of the reception of the audio data from the second auxiliary device 1102, the electronic device 101 performs WiFi communication in the sections except for the section in which the audio data is retransmitted to the second auxiliary device 1102.

As illustrated in FIG. 11, the electronic device 100 may additionally transmit control data 1113 and 1153 related to a control of the corresponding auxiliary device as well as audio data 1111 and 1151 in the first transmission sections 1110 and 1150 and receive ACK/NACK signals 1114 and 1154 indicating whether the control data is successfully received. When the NACK signal received in response to the control data, the electronic device 101 retransmits the control data in the second transmission section.

According to various embodiments, at least a part of a device (for example, modules or functions thereof) or a method (for example, operations) according to the various embodiments of the present disclosure may be embodied by, for example, a command stored in a computer readable storage medium in a form of a programming module. When an instruction is implemented by one or more processors (for example, the processor 140), the one or more processors may execute a function corresponding to the instruction. The computer-readable storage medium may be, for example, the memory 150. At least a part of the programming module may be implemented (for example, executed) by, for example, the processor 140. At least a part of the programming module may include, for example, a module, a program, a routine, a set of instructions and/or a process for performing one or more functions.

The computer-readable recording medium may include magnetic media such as a hard disk, a floppy disk, and a magnetic tape, optical media such as a compact disc read only memory (CD-ROM) and a digital versatile disc (DVD), magneto-optical media such as a floptical disk, and hardware devices specially configured to store and perform a program instruction (for example, programming module), such as a read only memory (ROM), a random access memory (RAM), a flash memory and the like. In addition, the program instructions may include high class language codes, which can be executed in a computer by using an interpreter, as well as machine codes made by a compiler. The aforementioned hardware device may be configured to operate as one or more software modules in order to perform the operation of various embodiments of the present disclosure, and vice versa.

A programming module according to the present disclosure may include at least one of the described component elements, a few of the component elements may be omitted, or additional component elements may be included. Operations executed by a module, a programming module, or other component elements according to various embodiments of the present disclosure may be executed sequentially, in parallel, repeatedly, or in a heuristic manner. Further, some operations may be executed according to another order or may be omitted, or other operations may be added.

The embodiments disclosed herein can be implemented through a System on Chip (SoC) platform. For example, the components illustrated in FIGS. 1, 2, 7, and 12, which are associated with the electronic devices 101, 1200, can be integrated on one or more substrates of an SoC.

In accordance with the embodiments described herein, the electronic device 101 encodes first audio data to be transmitted to a first auxiliary device 184 and second audio data to be transmitted to a second auxiliary device 186 to have a time gap within the same audio stream and transmits the encoded audio data, so that the first auxiliary device 184 and the second auxiliary device 186, which has no direct connection therebetween, can decode the audio data without regard to time synchronization with the counterpart auxiliary device. Accordingly, a load and complexity of the first auxiliary device 184 and the second auxiliary device 186 can be reduced.

When transmitting audio data by using a first communication scheme, the electronic device 101 controls activation of a second communication scheme in a retransmission section according to whether audio data is successfully transmitted in an initial transmission section, so that the second communication scheme may be activated when the audio data is successfully transmitted in the initial transmission section. Accordingly, the electronic device 101 can prevent data efficiency from deteriorating when the electronic device 101 uses the second communication scheme while transmitting audio data through the first communication scheme.

In accordance with the embodiments, an electronic device for transmitting audio data is proviced. The electronic device includes an audio data transmission control module for transmitting audio data to one or more auxiliary devices through a first wireless communication scheme in a first transmission section for audio data transmission and receiving a response signal, from the one or more auxiliary devices, indicating successful reception of the audio data through the first communication scheme and a communication scheme activation control module for activating a second wireless communication scheme in a part of a second transmission section for retransmission of the audio data.

In accordance with the embodiments, the second wireless communication scheme is activated after a time when the response signal is received in the first transmission section.

In accordance with the embodiments, the first communication scheme is a bluetooth low energy (BLE) communication scheme and the second communication scheme is a WiFi communication scheme.

In accordance with the embodiments, the communication scheme activation control module transmits and receives using the activated second wireless communication scheme in the part of the second transmission section, without transmitting and receiving using the first wireless communication scheme.

In accordance with the embodiments, the first transmission section is a section in which the audio data is initially transmitted using the first wireless communication scheme and the second transmission section is a section in which the audio data, if the audio data fails to transmit in the first transmission section, is retransmitted using the first wireless communication scheme.

In accordance with the embodiments, the audio data transmission control module transmits audio data through the first wireless communication scheme in a first transmission section of a first auxiliary device and transmits audio data through the first wireless communication scheme in a first transmission section of a second auxiliary device, and the first transmission section of the first auxiliary device and the first transmission section of the second auxiliary device are different sections having a time gap therebetween.

In accordance with the embodiments, when response signals indicating successful reception of the audio data are received from the first auxiliary device and the second auxiliary device, the communication scheme activation control module activates the second wireless communication scheme, and a second transmission section of the first auxiliary device and a second transmission section of the second auxiliary device are different section having a time gap therebetween.

In accordance with the embodiments, a system on chip (SoC) for transmitting audio data is provided. The SoC includes an audio stream encoding module for encoding first audio data of a first audio stream section included in an audio stream and encoding second audio data of a second audio stream section and a transmission time control module for transmitting the encoded first audio data to a first auxiliary device and transmitting the encoded second audio data to a second auxiliary device after a time corresponding to a predetermined interval.

In accordance with the embodiments, a system on chip (SoC) for transmitting audio data is provided. The SoC includes an audio data transmission control module for transmitting audio data to one or more auxiliary devices through a first wireless communication scheme in a first transmission section for audio data transmission and receiving a response signal, from the one or more auxiliary devices, indicating successful reception of the audio data through the first communication scheme and a communication scheme activation control module for activating a second wireless communication scheme in a part of a second transmission section for retransmission of the audio data.

While the present disclosure has been shown and described with reference to various embodiments thereof, it should be understood by those skilled in the art that many variations and modifications of the embodiments described herein will still fall within the spirit and scope of the present disclosure as defined in the appended claims and their equivalents.

What is claimed is:

1. A method of transmitting audio data by an electronic device, the method comprising:
encoding first audio data of a first audio stream section included in an audio stream;
encoding second audio data of a second audio stream section included in the audio stream;
transmitting the encoded first audio data to a first auxiliary device; and
transmitting the encoded second audio data to a second auxiliary device after a time corresponding to a predetermined interval.

2. The method of claim 1, wherein the second audio stream section has a starting point after the predetermined interval from a starting point of the first audio stream section, and
wherein a length of the second audio stream section is equal to a length of the first audio stream section.

3. The method of claim 1, wherein the first audio data and the second audio data are transmitted to the first auxiliary device and the second auxiliary device through a bluetooth low energy (BLE) communication scheme.

4. The method of claim 1, wherein the first auxiliary device and the second auxiliary device are wireless audio output devices.

5. The method of claim 1, wherein the predetermined interval indicates a time gap between the starting point of the first audio stream section and the starting point of the second audio stream section and is determined based on one of a time synchronization between the first auxiliary device and the second auxiliary device and a predetermined measurement.

6. A method of transmitting audio data by an electronic device, the method comprising:
transmitting audio data to one or more auxiliary devices through a first wireless communication scheme in a first transmission section for audio data transmission;
receiving a response signal, from the one or more auxiliary devices, indicating successful reception of the audio data s through the first wireless communication scheme; and
activating a second wireless communication scheme in a part of a second transmission section for retransmission of the audio data.

7. The method of claim 6, wherein activating the second wireless communication scheme occurs after a time when the response signal is received in the first transmission section.

8. The method of claim 6, wherein the first communication scheme is a bluetooth low energy (BLE) communication scheme and the second communication scheme is a WiFi communication scheme.

9. The method of claim 6, wherein activating the second wireless communication scheme in the part of the second transmission section for retransmission of the audio data comprises transmitting and receiving using the activated second wireless communication scheme in the part of the second transmission section, without transmitting and receiving using the first wireless communication scheme.

10. The method of claim 6, wherein the first transmission section is a section in which the audio data is initially transmitted using the first wireless communication scheme and the second transmission section is a section in which the audio data, if the audio data fails to transmit in the first transmission section, is retransmitted using the first wireless communication scheme.

11. The method of claim 6, wherein transmitting the audio data to the one or more auxiliary devices through the first wireless communication scheme in the first transmission section for audio data transmission comprises:
transmitting audio data through the first wireless communication scheme in a first transmission section of a first auxiliary device; and
transmitting audio data through the first wireless communication scheme in a first transmission section of a second auxiliary device,
wherein the first transmission section of the first auxiliary device and the first transmission section of the second auxiliary device are different sections having a time gap therebetween.

12. The method of claim 11, wherein activating the second wireless communication scheme in the part of the second transmission section for retransmission of the audio data comprises:
when response signals indicating successful reception of the audio data are received from the first auxiliary device and the second auxiliary device, activating the second wireless communication scheme,
wherein a second transmission section of the first auxiliary device and a second transmission section of the second auxiliary device are different sections having a time gap therebetween.

13. An electronic device for transmitting audio data, the electronic device comprising:
an audio stream encoding module for encoding a first audio stream section included in an audio stream and encoding a second audio stream section; and
a transmission time control module for transmitting first audio data acquired by encoding the first audio stream section to a first auxiliary device and transmitting second audio data acquired by encoding the second audio stream section to a second auxiliary device after a time corresponding to a predetermined interval.

14. The electronic device of claim 13, wherein the second audio stream section has a starting point after the predetermined interval from a starting point of the first audio stream section, and wherein a length of the second audio stream section is equal to a length of the first audio stream section.

15. The electronic device of claim 13, wherein the first audio data and the second audio data are transmitted to the first auxiliary device and the second auxiliary device through a bluetooth low energy (BLE) communication scheme.

16. The electronic device of claim 13, wherein the first auxiliary device and the second auxiliary device are wireless audio output devices.

17. The electronic device of claim 13, wherein the predetermined interval indicates a time gap between the starting point of the first audio stream section and the starting point of the second audio stream section and is determined based on one of a time synchronization between the first auxiliary device and the second auxiliary device and a predetermined measurement.
